(19) United States
(12) Patent Application Publication
(10) Pub. No.: US 2026/0178502 A1
(43) Pub. Date: Jun. 25, 2026

(54) APPARATUSES AND METHODS FOR CACHE MANAGEMENT BASED ON PRIORITY LEVELS

(71) Applicant: HUAWEI TECHNOLOGIES CO., LTD., SHENZHEN (CN)

(72) Inventors: Henry Fangli KAO, Kanata (CA); Nikhil SREEKUMAR, Kanata (CA); Reza AZIMI, Kanata (CA); Maziar GOUDARZI, Kanata (CA); Prabhdeep Singh SONI, Kanata (CA); Bryan Pak Kwai CHAN, Kanata (CA); Fang SU, Kanata (CA)

(73) Assignee: HUAWEI TECHNOLOGIES CO., LTD., SHENZHEN (CN)

(21) Appl. No.: 19/540,188

(22) Filed: Feb. 13, 2026

Related U.S. Application Data
(63) Continuation of application No. PCT/CN2024/102804, filed on Jul. 1, 2024.

(51) Int. Cl. G06F 12/0875; G06F 12/0888

(52) U.S. Cl. CPC G06F 12/0875; G06F 12/0888

(57) ABSTRACT

Embodiments of the present application provide systems and methods for improved cache management based on priority levels. Embodiments involve receiving program code with regions marked by execution frequency indicators, loading these regions into memory with assigned priority levels, and managing the processor's cache accordingly. Page table entries (PTEs) are generated to indicate priority levels, facilitating cache allocation based on these levels. Additionally, the method includes generating program code using an optimizer, enhancing cache management through user-set attributes and profile data. This approach can improve cache performance and overall system efficiency, making it a valuable advancement in cache management technology.

### CROSS-REFERENCE TO RELATED APPLICATIONS

This application is a continuation of International Patent Application No. PCT/CN2024/102804, filed on Jul. 1, 2024 and titled “APPARATUSES AND METHODS FOR CACHE MANAGEMENT BASED ON PRIORITY LEVELS”, which is hereby incorporated by reference in its entirety.

### TECHNICAL FIELD

The present disclosure pertains to the field of cache management, and in particular to apparatuses and methods for cache management based on priority levels.

### BACKGROUND

Modern applications, such as those in mobile and server workloads, have become increasingly complex, resulting in large instruction footprints. This complexity challenges conventional cache hierarchies, as cache sizes do not scale proportionately with the growing code footprints. Processors use caches to keep frequently accessed data close, reducing access latency. Efficient cache policies are relevant for optimizing the use of cache memory, determining which data should be retained or replaced based on various criteria. However, traditional cache policies can only observe a limited execution window to make these decisions, often leading to frequent cache misses and instruction starvation. This results in stall cycles, reducing overall performance and energy efficiency.

Existing cache management techniques introduce additional hardware overhead and complexity. Some methods require extra hardware to track and predict cache line usefulness, increasing power consumption and taking up valuable processor space. Other techniques necessitate the inclusion of additional instructions in the application code. These extra instructions require additional processing and can inflate the code size, further complicating optimization and potentially reducing overall performance.

Therefore, there is a need for systems and methods for cache management that obviates or mitigates one or more limitations of the prior art.

This background information is provided to reveal information believed by the applicant to be of possible relevance to the present application. No admission is necessarily intended, nor should be construed, that any of the preceding information constitutes prior art against the present application.

### SUMMARY

Embodiments of the present application provides systems, apparatus and methods for cache management based on priority levels. According to an aspect, a method for managing a cache is provided. The method includes receiving a program code, the program code including a plurality of regions. Each of one or more regions of the plurality of regions having a corresponding indicator indicative of an associated level of execution frequency or execution use. The method further includes loading the program code into a memory of a processor. Loading the program code into the memory includes assigning to each of the one or more regions of the plurality of regions loaded into the memory a priority level based on the corresponding indicator. The method further includes managing the cache of the processor running the program, where the managing is based on the assigned priority level of each of the one or more regions. The method may allow for improved cache management and performance.

In some embodiments, loading the program code into the memory includes generating page table entries (PTEs) corresponding to the one or more regions of the plurality of regions. In some embodiments, each PTE indicates the priority level of a corresponding region of the one or more regions. The method may mitigate instruction and code size overhead while also reducing the need for additional hardware to support new instructions.

In some embodiments, each PTE includes a field for indicating the priority level. In some embodiments, the field includes one or more bits for indicating the priority level.

In some embodiments, managing the cache of the processor includes obtaining an instruction of the program code from the memory, where the instruction indicates a priority level based on a corresponding PTE. In some embodiments, managing the cache of the processor further includes allocating the instruction within the cache based on the priority level.

In some embodiments, allocating the instruction within the cache based on the priority level includes inserting the instruction within the cache based on the priority level. In some embodiments, allocating the instruction within the cache based on the priority level includes replacing an existing instruction in the cache with the instruction based on the priority level. In some embodiments, allocating the instruction within the cache is further based on an underlying policy of the cache.

In some embodiments, the method further includes generating the program code including the plurality of regions. In some embodiments, the program code has an executable and linkable format (ELF). In some embodiments, generating the program code includes generating the program code using an optimizer (e.g., a compiler or a binary optimizer) based on input information indicating the one or more regions of the plurality of regions. The method may prevent or reduce instruction and code size overheads while allowing identification of execution frequency for one or more regions (e.g., which instructions are hot and cold in the ELF).

In some embodiments, the input information is based on profile data (or profiling data) or attributes set by a user of the program code. In some embodiments, the attributes are set in a program source fed to the optimizer for generating the programing code.

According to another aspect, a (e.g. non-transitory) computer readable medium, computer program, or computer program product, comprising stored thereon statements and instructions which, when executed by a computer processor perform one or more methods described herein.

According to another aspect, an apparatus or system is provided, where the apparatus includes modules configured to perform one or more methods described herein. According to another aspect, another apparatus or system is provided that includes computing electronics and is configured to perform the methods described herein. According to another aspect, another apparatus is provided that includes processing and wireless communication electronics and is configured to operate as described herein.

According to another aspect, a method is provided for execution by processing and wireless communication electronics. The method includes performing operations as described herein. In some embodiments a computer program product is provided. The computer program product includes a non-transitory computer readable medium having recorded thereon statements and instructions which, when executed by a computer, cause the computer to perform one or more methods described herein.

According to another aspect, a chip is provided, where the chip includes a processor and a data interface, and the processor reads, by using the data interface, an instruction stored in a memory, to perform the different aspects described herein.

Other aspects of the application provide for apparatus, and systems configured to implement the methods according to the different aspects disclosed herein. For example, wireless stations and access points can be configured with machine readable memory containing instructions, which when executed by the processors of these devices, configures the device to perform the methods disclosed herein.

Embodiments have been described above in conjunction with aspects of the present application upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present application will become apparent from the following detailed description, taken in combination with the appended drawings, in which:

FIG. 1 illustrates a program code, according to an embodiment.

FIG. 2 illustrates a system architecture, according to an embodiment.

FIG. 3 illustrates a flowchart for generating PTEs, according to an embodiment.

FIG. 4 illustrates a PTE format, according to an embodiment.

FIG. 5 illustrates a flowchart for managing a cache, according to an embodiment.

FIG. 6 illustrates a method of managing a cache, according to an embodiment.

FIG. 7 illustrates a method of transforming a program code, according to an embodiment.

FIG. 8 illustrates performance results, according to an embodiment.

FIG. 9 is a schematic diagram of an apparatus or an electronic device that may perform any or all of the operations of the above methods and features explicitly or implicitly described herein, according to different embodiments of the present application.

It will be noted that throughout the appended drawings, like features are identified by like reference numerals.

### DETAILED DESCRIPTION

Embodiments of the present application provide system and methods for cache management. Embodiments involves receiving a program code that includes distinct regions, each identified by an execution frequency indicator. These regions are then loaded into the processor's memory, with each region being assigned a priority level based on its execution frequency indicator. Subsequently, the processor's cache is managed based on these priority levels, enabling frequently accessed regions to be prioritized for improved cache utilization. This process is facilitated by generating PTEs corresponding to each region, wherein each PTE contains a field indicating the priority level. Additionally, the method encompasses an optimizer that generates the program code, based on user-defined attributes or profile data. The method may allow for improving cache management and overall system performance.

As may be appreciated, the terms “hot” and “cold” are used in this present application to represent instructions in a program that are executed more or less frequently. A region of instructions in a program is considered hot, when the region occupies a considerable portion of the program's dynamic execution count. Conversely, a region of instructions in a program is considered cold when it is infrequently executed and does not make up a significant portion of the program's dynamic instruction count. In some embodiments, hot and cold are indicators indicative of an associated level of execution frequency.

Embodiments of the present disclosure relate to cache management based on cache policies. Cache policies define the rules and strategies for managing cache memory, including how and when data is inserted into and replaced within the cache. These cache policies can encompass both insertion policies, which determine how new cache lines are added, and replacement policies, which dictate how existing cache lines are replaced to make room for new ones. Reference to a cache policy refers to any appropriate policy that can be used to manage the insertion and replacement of information in memory of the cache as may be appreciated.

Processors may contain multi-level on-chip caches to keep frequently accessed data closer to the processors, reducing access latency compared to the slower accesses to main memory or dynamic random-access memory (DRAM). Cache policies are necessary for determining what data stays in the cache and what should be excluded. Memory that is most frequently used in a phase of a process can be prioritized by these policies and kept in the caches closest to the processor. Memory that is infrequently used can be de-prioritized. Typically, cache policies can select the subset of memory that is infrequently used as candidates for eviction from the cache.

Modern applications in areas such as mobile and server workloads are becoming increasingly complicated, with deep software stacks, high-level language constructs, and numerous system calls, leading to large instruction footprints. It has been realized that conventional cache hierarchies are unable to effectively store processes with large code footprints, as cache sizes do not grow at a rate that matches the increase in code footprint.

Additionally, conventional cache policies struggle to keep up with the demands of modern workloads, as they can only observe a relatively small window of program execution to decide which memory to retain in the cache. As a result, the processor front-end experiences instruction starvation due to frequent cache misses on instruction memory in processes with large code footprints. This instruction starvation can lead to stall cycles in the rest of the processor pipeline, limiting performance and throughput and decreasing energy efficiency.

In profile-guided code optimization, a profile is collected from an application running a representative workload. The profile is fed back into the program optimizer, and the application is re-optimized using this profile, often yielding a more optimized and better-performing application. Profile information (or profiling information or data), along with the profile-guided optimized application, can provide additional information, such as identifying which parts of the code constitute a significant portion of the total dynamic instruction count (hot code) and which parts have an insignificant contribution (cold code).

Profile information can provide a global, end-to-end characterization of the application, which pure hardware techniques like cache policies cannot capture. According to some embodiments, profile information is passed to the cache policies to better guide which instruction memory to prioritize in the caches. This approach aims to decrease processor frontend stalls and thereby increase performance.

An existing replacement policy is Belady's cache replacement policy, also known as the optimal cache replacement policy, which discards memory from the cache that will not be needed for the longest time in the future. However, this replacement policy requires future knowledge of the memory access pattern, making it infeasible in practice.

Another existing technique, Hawkeye cache replacement, attempts to make a feasible implementation of the optimal cache replacement policy. It tracks past histories of cache accesses in an additional hardware table. A binary classifier determines if an incoming cache line is worth keeping in the cache for longer or should be evicted as soon as possible based on the past history tracked by the additional hardware. The insertion policy then inserts the cache line at a higher or lower priority in the cache, depending on whether the binary classifier predicts that the cache line should be kept or evicted soon.

Another existing approach, thermometer branch target buffer (BTB) replacement, targets the cache replacement mechanism for the BTB, an on-chip cache storing branch instructions and their target addresses. This method uses profile-guided optimization (PGO) to determine which branches are most frequently executed in the program and which are not. Frequently executed branches are prioritized by the BTB replacement policy to remain in the BTB for a longer duration, whereas less frequently executed branches are more likely candidates for eviction.

It has been realized that existing techniques for cache management introduce several challenges. One issue is the hardware overhead associated with these methods. For example, approaches like Hawkeye require additional hardware to track and predict whether cache lines should be retained in the cache. This added hardware not only consumes more power and space in the processor but can also lead to feasibility issues in implementation. The increased complexity can extend the critical path within the processor pipeline, potentially forcing the processor to operate at a slower clock frequency, impacting overall performance.

Moreover, these techniques can result in instruction overhead. Techniques such as Thermometer rely on profiling to determine branch execution frequency throughout the application's lifespan. However, conveying this information to the hardware necessitates the inclusion of additional instructions in the application code. These extra instructions require additional processing by the processor, which can be costly in terms of performance. Furthermore, the insertion of new instructions can inflate the code size of the application, further complicating the optimization process.

According to some embodiments, methods are provided for guiding cache management and cache policies. These methods may involve minimal or negligible hardware modifications and avoid or reduce instruction overhead.

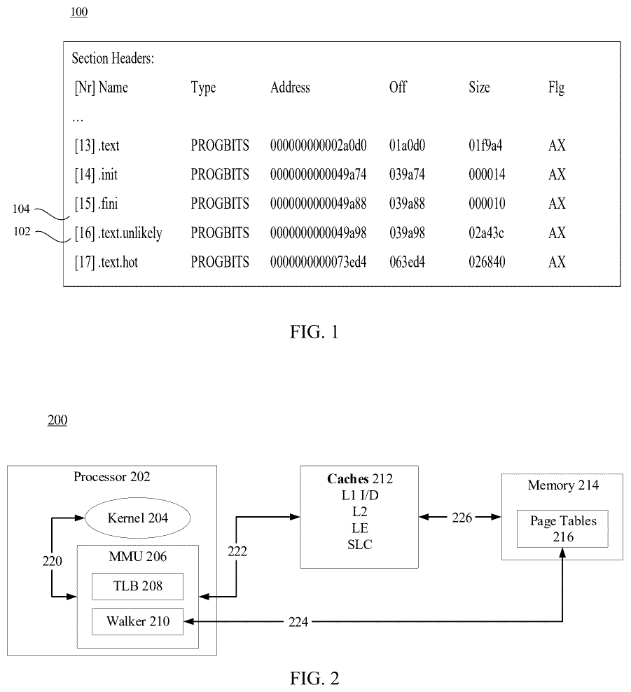

FIG. 1 illustrates a program code, according to an embodiment. The program code 100 is an example output of Linux ‘readelf’ showing hot and cold sections 102 and 104, respectively, in executable and linkable format (ELF) for a sample application. As illustrated, the program code or ELF file 100 indicates various sections or regions including .text, .text.unlikely, and .text.hot. In an embodiment, the .text.hot and .text.unlikely sections are used to separate hot and cold codes. The .text.hot section includes code that is frequently executed. The .text.unlikely section includes code that is infrequently executed. The labels .text.hot and .text.unlikely, similar to hot and cold terminology, may be understood as indicators indicative of an associated level of execution frequency.

According to an embodiment, profile-guided information and optimization, referred to as profile guided optimization (PGO), is used to classify or indicate which instruction memory is frequently executed (hot) or infrequently executed (cold). The optimized ELF file organizes or groups hot and cold instructions into separate sections within the ELF structure. These sections are uniquely identified and marked within the ELF, facilitating their recognition or identification by the ELF loader during subsequent processes. FIG. 1 depicts sections of a sample program compiled using PGO, wherein hot and cold instructions are separated into distinct sections within the ELF and labeled as .text.hot and .text.unlikely, respectively.

As may be appreciated, ELF is a file format for executables, object code, shared libraries, and core dumps. The ELF loader is a part of the operating system responsible for loading an executable file into memory, preparing it for execution. It reads the ELF file, interprets the headers, and maps the different sections (like code and data) into the appropriate locations in memory.

In some embodiments, when the application is run or executed, the ELF loader maps the ELF instruction memory into different parts of the processor's physical memory. In some embodiments, this mapping utilizes one or more page tables. During the generation of the page table(s) and its corresponding page table entries (PTEs), additional metadata is incorporated into each PTE to indicate or assign a priority level based on whether the page contains hot or cold instruction memory, as identified previously. This hot or cold metadata, indicating an assigned priority level, in each PTE is subsequently used by the cache policy to optimize program execution.

A page table may refer to a data structure used by the operating system to manage the mapping between virtual memory addresses and physical memory addresses. Each PTE in the page table corresponds to a page (e.g. a fixed-size block of memory). A PTE contains information about how a virtual page is mapped to a physical page in memory, including metadata about permissions (e.g. read/write), presence in memory, and hot or cold classification. In some embodiments, when a code is classified as hot or cold, this information is embedded in the ELF file. The ELF loader will later use this information to map the instructions into memory.

In some embodiments, the ELF loader loads the program into memory, using the ELF headers to determine where to place each section of code. As the loader maps these sections, it creates entries in the page table for each memory page. The page table contains PTEs that describe how each virtual memory page maps to a physical memory page. As the program is loaded, the operating system creates entries in the page table for the loaded pages. These PTEs are augmented with additional metadata indicating assigned priority levels, indicating whether the page contains hot or cold instructions.

In some embodiments, the additional metadata, e.g., assigned priority levels, in the PTEs for instruction memory is conveyed or passed with memory requests, transactions, or accesses occurring within the cache hierarchy during the application's runtime. In some embodiments, the cache uses this metadata, including the assigned priority levels, to apply the cache policy when inserting and replacing cache lines.

During runtime, when the processor needs to access memory, it generates memory requests. These requests involve translating virtual addresses to physical addresses using one or more page tables. As the memory request is processed, the system reads the corresponding PTE to determine the physical address and other attributes of the page. In some embodiments, the assigned priority level stored in the PTE is included with the memory request, tagging the transaction with this information (e.g. the assigned priority level). Accordingly, when the cache receives a request to load a piece of memory, it knows whether that memory is classified as hot or cold based on the metadata from the PTE, which indicates the assigned priority level.

In some embodiments, if the cache policy determines that a new cache line comes from a hot PTE (e.g., the PTE indicates a high priority level), the cache according to the cache policy prioritizes the cache line to retain it in the cache for a longer duration. Similarly, if the cache policy determines that the new cache line is from a cold PTE (e.g., the PTE indicates a low priority level), the cache, according to the cache policy, de-prioritizes the cache line to evict it from the cache sooner.

One or more embodiments described herein may apply to any cache policy, including but not limited to least recently used (LRU) and re-reference interval prediction (RRIP). Embodiments may apply to any machine that processes program instructions and has a caching mechanism to store instructions and data whether using a cache policy or not. Some embodiments may apply to any software tool that generates or optimizes code, which may include, but not limited to, compilers and binary optimization tools.

FIG. 2 illustrates a system architecture, according to an embodiment. The system architecture 200 is an example architecture to which one or more embodiments apply. As illustrated, the system architecture includes one or more of the following components: a processor 202, a cache 212, and a memory 214. The processor 202 includes a kernel 204 and a memory management unit (MMU) 206. The MMU 206 includes a translation lookaside buffer (TLB) 208 and a walker 210. The kernel 204 is connected 220 to the MMU 206. The MMU 206 is connected 222 to the cache 212. The MMU 206, via the walker 210 is connected 224 to the memory 214. The cache 212 is further connected 226 to the memory 214 as illustrated. The memory 214 includes one or more page tables 216.

In some embodiments, the processor 202 handles the instruction and data processing of the application or program. The kernel 204 or operating system (OS) runs on the processor and contains mechanisms to generate the one or more page tables 216 stored in the memory 214. Within the processor 202, instructions and data are referenced based on virtual addresses. In the caches 212 and the memory 214, instructions and data are referenced based on physical addresses. The MMU 206 in the processor 202, which contains the TLB 208, performs the virtual to physical address translation, acting as an interface between the processor 202 and the cache/memory hierarchy. As may be appreciated, the cache/memory hierarchy refers to the structured organization of different levels of cache and memory within a computer system. It represents the arrangement of memory storage that ranges from the fastest and smallest cache levels to the slower and larger main memory. Each level of the hierarchy serves to optimize data access speed and efficiency.

The cache hierarchy may include, but not limited to private L1 instruction and data caches, L2 caches, L3 caches, system level caches prior to accessing main memory.

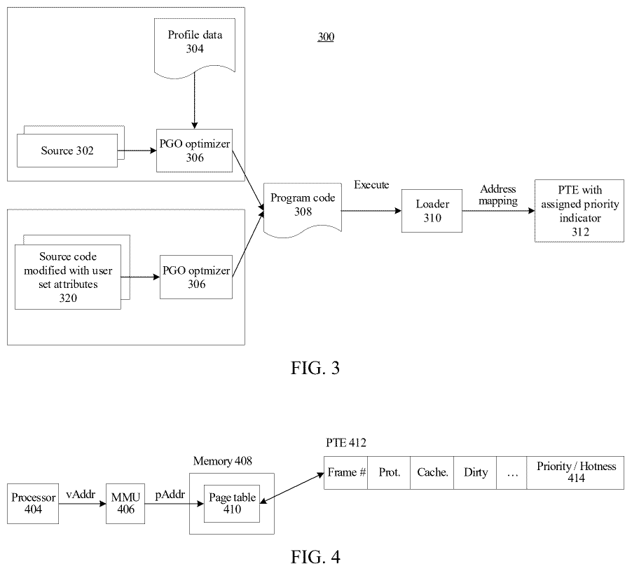

FIG. 3 illustrates a flowchart for generating PTEs, according to an embodiment. Flowchart 300 may represent a method for generating page tables with PTEs. In some embodiments, the PTEs include metadata assigning a priority level to the corresponding page based on the execution frequency (or a degree or level of execution frequency) of the instructions in the corresponding page. The execution frequency may refer to the degree of hotness or coldness of the instructions. In some embodiments, a cache and its policy may use the metadata indicating assigned priority levels when accessing PTEs.

According to an embodiment, flowchart 300 includes passing an application or program source 302 to the PGO optimizer 306. The source 302 may be one or more separate files, which can be source code, executables, or some intermediate form. In some embodiments, the PGO optimizer 306, which may take the form of a compiler or binary optimizer, receives as input the source 302 and profile data 304 (or profiling data or information) collected from running the application or program on a representative workload.

The PGO optimizer 306 generates a program code 308 based on the received input. In some embodiments, the program code 308 is an ELF file or a new ELF file that includes hot and cold instruction code grouped and split into different regions (e.g. sections) of the ELF file (e.g. similar to program code 308). In some embodiments, the ELF file includes unique metadata or markers indicating which regions in the ELF correspond to the hot or cold instruction code. The unique metadata or markers include indicators indicative of a level of execution frequency. In some embodiments, the ELF file may be a program code that includes a plurality of regions, where each of one or more regions of the plurality of regions has a corresponding indicator indicative of an associated level of execution frequency. Each region of the one or more regions of the plurality of regions of the program code may refer to one or more of the following: instructions, functions, components, segments, sections, pages, and the like. In some embodiments, each region of at least one region of program code may have a corresponding indicator indicative of an associated level of execution frequency.

In some embodiments, the program source may be modified to indicate at least one region, where each region has a corresponding indicator reflecting its associated level of execution frequency. For example, the program source code may be modified with user-set attributes that identify the at least one region. In some embodiments, the modified program source 320 is then fed to the PGO optimizer 306 to generate the program code 308.

The generated program code 308 is then executed. When executed, the program code is mapped to memory by creating PTEs 312 for the program code through the loader 310. In some embodiments, the loader 310 reads the hot and cold regions (e.g., the indicators indicating level of execution frequency) in the program code 308 and populates one or more PTEs with hot or cold metadata (assigned priority levels) accordingly. In some embodiments, the one or more PTEs with assigned priority levels correspond to the at least one region of the program code, where each of the at least one region has a corresponding indicator indicative of an associated level of execution frequency.

In some embodiments, the one or more PTEs with hot or cold metadata (e.g. assigned priority levels) are then used by the cache system during memory access. The cache uses this metadata (e.g. indicating assigned priority level(s)) under its policy to make decisions about which cache lines to prioritize or evict.

FIG. 4 illustrates a PTE format, according to an embodiment. When loading an application, the processor 404 and MMU 406 map or translate virtual addresses (e.g. vAddr) to physical addresses (e.g. pAddr) using one or more page tables 410 in the memory 408. Processor 404 may be similar to processor 202, and memory 408 may be similar to memory 214.

In an embodiment, the OS allocates virtual memory address to different parts of the program code. During application execution, the processor 404 generates virtual addresses, and the MMU 406 (which may be similar to MMU 206) references these addresses in the page table 410 to retrieve the corresponding physical addresses. Accordingly, the generated virtual addresses are sent to MMU 406, and the MMU 406 translates the virtual addresses to physical addresses which are then used to access the page table 410.

In some embodiments, each page table includes one or more PTEs. Each PTE 412 includes one or more fields indicating attributes of a corresponding virtual page. For example, a PTE 412 includes control bits and metadata indicating details such as the frame number, some permissions (e.g., read-only, write-only, read-write, caching status, modification indicator (e.g. dirty), and others relevant information.

In some embodiments, the PTE 412 includes a field to indicate an assigned priority level or a degree of hotness or coldness of the instructions mapped to the PTE. In some embodiments, this field includes one or more bits, allowing for varying levels of priority level indication. For example, the PTE can indicate at least one level of priority, such as high or hot priority. Alternatively, it may indicate two levels of priorities, including high or hot priority and low or cold priority. Furthermore, in some embodiments, the PTE can represent a range of priorities, utilizing multiple bits to provide a finer granularity of priority levels or indicators.

In some embodiments, when the cache accesses memory and the MMU translates the virtual address to a physical address, the cache can use the priority indicator 414 in the PTE to manage the cache. For example, if the priority field indicates that the instructions are “hot” or a high priority level (e.g., frequently accessed), the cache may prioritize keeping the corresponding cache lines in the cache for an extended period. Conversely, if the PTE indicates a lower priority or cold instructions (e.g., infrequently accessed), the cache may choose to evict those cache lines to make room for more frequently accessed instructions (e.g. higher priority).

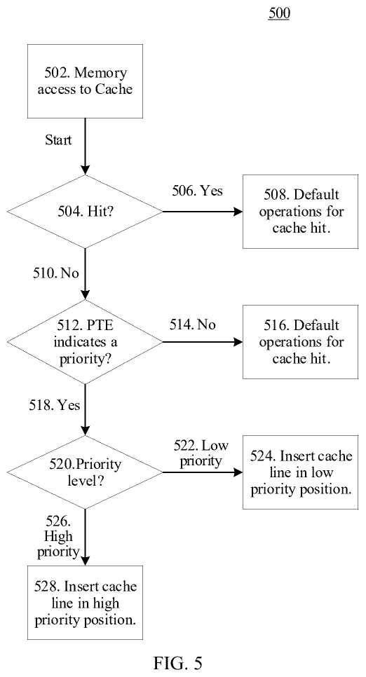

FIG. 5 illustrates a flowchart for managing a cache, according to an embodiment. Flowchart 500 may represent a method for managing a cache. The flowchart 500 may apply to any appropriate cache and its corresponding cache policy. According to an embodiment, the cache policy is triggered by a memory access to the cache 502. In some embodiments, instruction memory may have an assigned priority level via metadata attached to the memory request coming from the corresponding PTE 412.

Following memory access, flowchart 500 proceeds to determine 504 whether the cache returns a hit or a miss. In some embodiments, if the cache returns a hit 506 for the instruction memory access (e.g. indicating that the cache line for the relevant instruction address is already present in the cache), the cache policy mechanism or cache policy remains inactive as there is no need for insertion or replacement. Accordingly, the cache performs 508 its default operations in the case of the cache hit.

In some embodiments, if the cache responds with a miss 510, then the policy is triggered since the cache line for the instruction memory request needs to be allocated to the cache.

Following the determination that the cache returns a miss, flowchart 500 proceeds to determine 512 whether the memory access includes or indicates a priority level.

In some embodiments, if the memory access lacks a priority level or indicates a null priority 514, then the cache follows its default behavior 516. In some embodiments, the memory access lacks priority level when the memory access lacks priority metadata (or the PTE lacks a priority field) indicating that the instruction (or the corresponding page where the instruction resides) has not been assigned a priority level. In some embodiments, the memory access indicates a null priority when the priority metadata or the associated PTE indicates a null value. This null value indicates that the cache may apply its default settings according to its underlying policy. Under its default operation, the cache may choose a candidate for eviction to make space for the incoming cache line. The cache may allocate the incoming cache line based on the default behavior of the underlying policy.

In some embodiments, the memory access includes 518 a priority metadata that indicates a priority level (e.g. a none-null value for the priority level). The cache accessing this priority metadata may read this metadata and determine 520 the priority level (e.g., a degree of hotness or coldness). In some embodiments, cache accesses with cold metadata (e.g., lower priority levels indicated by the PTE) 522 are inserted 524 into a lower priority position. In some embodiments, cache accesses with hot metadata (e.g., higher priority levels) 526 are inserted 528 into a higher priority position.

In some embodiments, the definition of higher and lower priority can vary between different underlying cache policies that a cache can operate on. For example, high and low priority positions can be a binary decision in an LRU replacement policy by inserting either into the most recently used (MRU) position for high priority, or least recently used (LRU) position for low priority. In some policies, such as RRIP, a range of integer values is used to denote the priority of a cache line, where a lower value indicates a higher priority.

In some embodiments, one or more regions of a program code are marked, where each region has a corresponding indicator indicative of an associated level of execution frequency. In some embodiments, one or more regions with similar level of execution frequency are grouped together within the program code. In some embodiments, a PGO optimizer is used to mark regions in the ELF with corresponding indicators of level of execution frequency (e.g., hot and cold instruction code).

Embodiments may avoid adding new instructions into the code. This approach may prevent or reduce instruction and code size overheads while allowing identification of execution frequency for one or more regions (e.g., which instructions are hot and cold in the ELF).

According to some embodiments, PTEs are generated for instruction memory, where each of one or more PTEs include a field for indicating an assigned priority level based on a corresponding level of execution frequency.

In some embodiments, PTEs with priority metadata are used to transfer information from PGO to the hardware without introducing new instructions in the program. This approach may mitigate instruction and code size overhead while also reducing the need for additional hardware to support new instructions.

According to some embodiments, a cache may use priority metadata (e.g. indicating an assigned priority level) from PTEs to manage its cache lines in combination with or independent of a cache policy. The use of priority metadata may allow a cache to keep more frequently used memory for longer periods and evict less frequently used memory sooner, potentially improving processor performance.

As described herein, one or more embodiments use indicators of execution frequency (e.g., hot and cold information provided by PGO) to influence or affect the cache policies within the processor's cache and memory hierarchy. As may be appreciated, one or more embodiments may further apply to other cache like structures, both within the processor (e.g., branch predictor table like BTB which have their own insertion and replacement policies) and external system. Embodiments described herein may apply to any system employing insertion and replacement policies that can leverage priority level indicators or similar metrics.

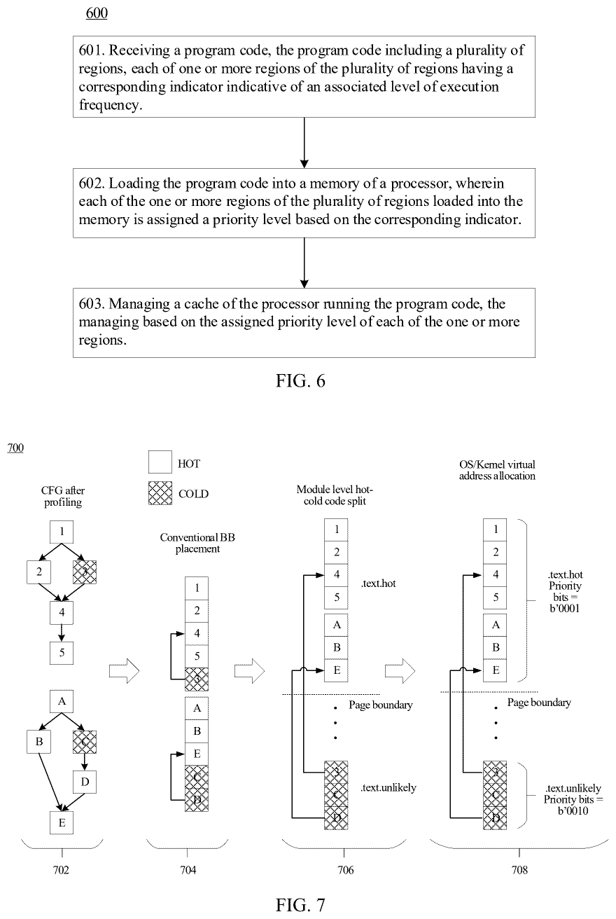

FIG. 6 illustrates a method of managing a cache, according to an embodiment. The method 600 includes receiving 601 a program code. The program code includes a plurality of regions, where each of one or more regions of the plurality of regions has a corresponding indicator indicative of an associated level of execution frequency. A region may refer to one or more of instruction(s), function(s), component(s), segment(s), section(s), portion(s), page(s) and the like.

The method 600 further includes loading 602 the program code into a memory of a processor. Each of the one or more regions of the plurality of regions loaded into the memory is assigned a priority level based on the corresponding indicator. The method 600 further includes managing 603 the cache of the processor running the program code, where the managing is based on the assigned priority level of each of the one or more regions.

In some embodiments, loading the program code into the memory includes generating one or more page tables based on the one or more regions. In some embodiments, loading the program code into the memory further includes, for each page table of the one or more page tables, generating one or more page table entries (PTEs) corresponding to the one or more regions of the plurality of regions.

In some embodiments, each PTE indicates the priority level based on a corresponding region of the one or more regions. In some embodiments, each PTE includes a field for indicating the priority level. In some embodiments, the field includes one or more bits for indicating the priority level.

In some embodiments, managing the cache of the processor includes obtaining an instruction of the program code from the memory, where the instruction indicates a priority level based on a corresponding PTE. In some embodiments, managing the cache of the processor further includes allocating the instruction within the cache based on the priority level.

In some embodiments, allocating the instruction within the cache based on the priority level includes inserting the instruction within the cache based on the priority level. In some embodiments, allocating the instruction within the cache based on the priority level includes replacing an existing instruction in the cache with the instruction based on the priority level. In some embodiments, allocating the instruction within the cache is further based on an underlying policy of the cache.

In some embodiments, the method further includes generating the program code including the plurality of regions. In some embodiments, the program code has an executable and linkable format (ELF). In some embodiments, generating the program code includes generating the program code using an optimizer (e.g., a compiler or a binary optimizer) based on input information indicating the one or more regions of the plurality of regions.

In some embodiments, the input information is based on profile data (or profiling data) or attributes set by a user of the program code. In some embodiments, the attributes are set in a program source fed to the optimizer for generating the programing code.

FIG. 7 illustrates a method of transforming a program code, according to an embodiment. The method 700 involves using profiling information to improve cache usage by distinguishing between hot and cold code during compilation. According to an embodiment, at 702, a compiler, using PGO, receives both the source code and profiling data collected from running the application. The compiler may identify frequently executed (e.g. hot) and infrequently executed (e.g. cold) code segments. In the example, clear blocks represent hot code, and crosshatched blocks represent cold code.

In some embodiments, at 704, during code layout in an executable format, the compiler arranges hot instructions closer together while placing cold instructions separately. Instructions are organized on a per-function basis, with hot blocks grouped together and cold blocks placed at the end to optimize the instruction cache.

In some embodiments, at 706, the compiler further splits the hot and cold code into different sections of the executable. Hot code is grouped and labeled as “.text.hot,” while cold code is grouped and labeled as “.text.cold” or “.text.unlikely.” In some embodiments, at 708, when the application is loaded into memory, the OS or kernel loader utilizes the newly generated executable's labeled sections. In some embodiments, new bits are set within the PTE to indicate whether a block of code loaded into memory is hot or cold. For instance, hot code sections are marked with a unique value, e.g., b'0001, and cold code sections with another unique value, e.g., b'0010.

Method 700 may improve cache efficiency by ensuring that frequently accessed (e.g. hot) code remains in the cache longer, while infrequently accessed (e.g. cold) code is quickly replaced.

According to an embodiment, an execution trace profiling was conducted using HiNextBench simpoints to identify frequently executed (hot) instruction code regions. The experiment involved selecting the top N % (e.g. with N being 20, 40, 60, 80, and 100) of basic blocks (BBs) as hot, emulating a hot-cold code splitting mechanism. These top N% BBs were marked as hot by setting appropriate priority bit(s). The L2 cache replacement policy was modified to prioritize these hot transactions by inserting them into RRPV 0 (e.g. the highest priority), in contrast to the default RRPV of 2. The evaluation was performed on the gem 5 simulator, modeling the LC920 core, with the cache configurations as follows: L1 instruction cache and L1 data cache, each 64 kB and 4-way associative with LRU replacement, and an L2 cache of 256 kB, 8-way associative with BRRIP replacement.

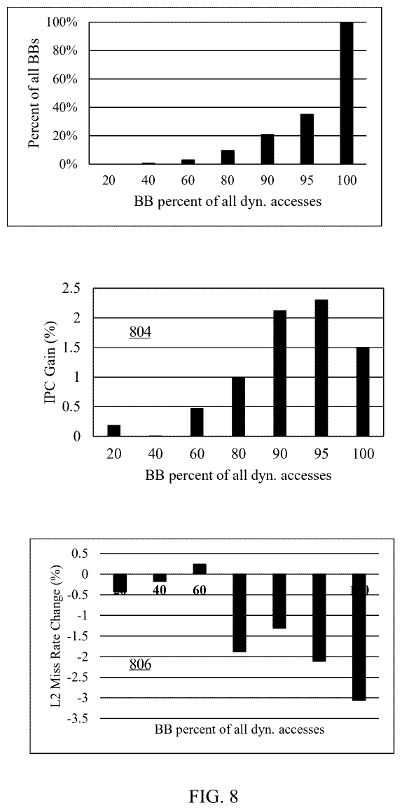

FIG. 8 illustrate performance results, according to an embodiment. The results in FIG. 8 demonstrate that the fraction of BBs constituting N % of all dynamic accesses effectively simulated application profiling and hot/cold code selection. Referring to graph 804, an increase in instructions per cycle (IPC) gain of approximately 2.2% was observed when prioritizing cache lines for around 35% of the BBs. When 100% of the instruction cache lines were considered hot, the IPC gain decreased to 1.5%, indicating that selective hot code definition may be more beneficial than over-classifying all code as hot. Additionally, referring to graph 806, a reduction in L2 cache misses was observed, indicating an improvement in both instruction and data cache efficiency, which may enhance overall performance.

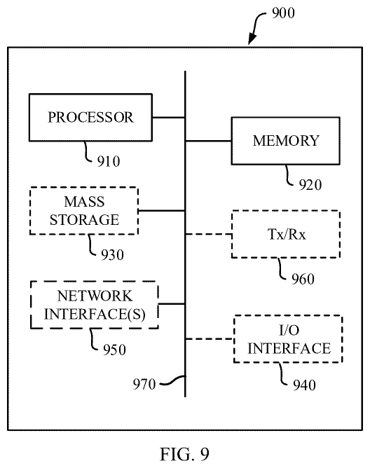

FIG. 9 is a schematic diagram of an apparatus or an electronic device 900 that may perform any or all of operations of the above methods and features explicitly or implicitly described herein, according to different embodiments of the present application. For example, a computer equipped with network function may be configured as apparatus 900. In some embodiments, apparatus 900 can be a device that connects to the network infrastructure over a radio interface, such as a mobile phone, smart phone or other such device that may be classified as user equipment (UE). In some aspects, the apparatus 900 may be a machine type communications (MTC) device (also referred to as a machine-to-machine (M2M) device), or another such device that may be categorized as a UE despite not providing a direct service to a user. In some embodiments, apparatus 900 performs one or more operations in one or more embodiments described herein. In some embodiments the apparatus 900 is based on the system architecture 200. In some embodiments, the apparatus can be embodied in one or more different forms, including but not limited to, a compiler, a processor, a cache, a system, a chip, a non-transitory computer-readable medium, a software application, a hardware module, a cloud-based service, or a combination thereof.

As shown, the apparatus 900 may include a processor 910, such as a central processing unit (CPU) or specialized processors such as a graphics processing unit (GPU) or other such processor unit, memory 920, non-transitory mass storage 930, input-output interface 940, network interface 950, and a transceiver 960, all of which are communicatively coupled via bi-directional bus 970. According to certain embodiments, any or all of the depicted elements may be utilized, or only a subset of the elements. Further, apparatus 900 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 920 may include any type of non-transitory memory such as static random access memory (SRAM), dynamic random access memory (DRAM), synchronous DRAM (SDRAM), read-only memory (ROM), any combination of such, or the like. The mass storage 930 may include any type of non-transitory storage device, such as a solid state drive, hard disk drive, a magnetic disk drive, an optical disk drive, USB drive, or any computer program product configured to store data and machine executable program code. According to certain embodiments, the memory 920 or mass storage 930 may have recorded thereon statements and instructions executable by the processor 910 for performing any of the aforementioned method operations described above.

In other embodiments, the apparatus may be embodied as a compiler or a software program executed by the processor 910. The compiler may include modules or components configured to perform the methods described herein. These modules can be loaded into memory 920 and executed by processor 910 to generate optimized program code based on profiling information and manage an associated cache according to one or more embodiments.

Embodiments of the present application can be implemented using electronics hardware, software, or a combination thereof. In some embodiments, the application is implemented by one or multiple computer processors executing program instructions stored in memory. In some embodiments, the application is implemented partially or fully in hardware, for example using one or more field programmable gate arrays (FPGAs) or application specific integrated circuits (ASICs) to rapidly perform processing operations.

In this application, “at least one” means one or more, and “a plurality of” means two or more. “and/or” describes an association relationship of associated objects, and indicates that there may be three relationships. For example, A and/or B may indicate cases includes “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent a, b, c, “a and b”, “a and c”, “b and c”, or “a, b and c”, where a, b, and c may be a single or multiple form.

It will be appreciated that, although specific embodiments of the technology have been described herein for purposes of illustration, various modifications may be made without departing from the scope of the technology. The specification and drawings are, accordingly, to be regarded simply as an illustration of the application as defined by the appended claims, and are contemplated to cover any and all modifications, variations, combinations or equivalents that fall within the scope of the present application. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present application may be implemented by using hardware only or by using software and a necessary universal hardware platform. Based on such understandings, the technical solution of the present application may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the embodiments of the present application. For example, such an execution may correspond to a simulation of the logical operations as described herein. The software product may additionally or alternatively include a number of instructions that enable a computer device to execute operations for configuring or programming a digital logic apparatus in accordance with embodiments of the present application.

Although the present application has been described with reference to specific features and embodiments thereof, it is evident that various modifications and combinations can be made thereto without departing from the application. The specification and drawings are, accordingly, to be regarded simply as an illustration of the application as defined by the appended claims, and are contemplated to cover any and all modifications, variations, combinations or equivalents that fall within the scope of the present application.

1. A method comprising:
receiving a program code, the program code including a plurality of regions, each of one or more regions having a corresponding indicator indicative of an associated level of execution frequency;
loading the program code into a memory of a processor, wherein each of the one or more regions of the plurality of regions loaded into the memory is assigned a priority level based on the corresponding indicator; and
managing a cache of the processor running the program code, the managing based on the assigned priority level of each of the one or more regions.

2. The method of claim 1, wherein loading the program code into the memory comprises generating page table entries, PTEs, corresponding to the one or more regions of the plurality of regions, each PTE indicating the priority level based on a corresponding region of the one or more regions.

3. The method of claim 2, wherein each PTE includes a field for indicating the priority level, the field including one or more bits.

4. The method of claim 2, wherein managing the cache of the processor comprises:
obtaining an instruction of the program code from the memory, the instruction indicating a priority level based on a corresponding PTE; and
allocating the instruction within the cache based on the priority level.

5. The method of claim 4, wherein allocating the instruction within the cache based on the priority level comprises: inserting the instruction within the cache based on the priority level or replacing an existing instruction in the cache with the instruction based on the priority level.

6. The method of claim 4, wherein allocating the instruction within the cache is further based on an underlying policy of the cache.

7. The method of claim 1, further comprising generating the program code including the plurality of regions.

8. The method of claim 7, wherein the program code has an executable and linkable format (ELF) and generating the program code comprises generating the program code using an optimizer based on input information indicating the one or more regions of the plurality of regions.

9. The method of claim 8, wherein the input information is based on profile data or attributes set by a user of the program code, wherein the attributes are set in a program source fed to the optimizer for generating the programing code.

10. A non-transitory computer-readable medium, a computer program, or a program product, each comprising instructions that, when executed by a processor, cause the processor to:
receive a program code, the program code including a plurality of regions, each of one or more regions having a corresponding indicator indicative of an associated level of execution frequency;
load the program code into a memory of a processor, wherein each of the one or more regions of the plurality of regions loaded into the memory is assigned a priority level based on the corresponding indicator; and
manage a cache of the processor running the program code, the managing based on the assigned priority level of each of the one or more regions.

11. The non-transitory computer-readable medium, a computer program, or a program product, of claim 10, wherein loading the program code into the memory comprises generating page table entries, PTEs, corresponding to the one or more regions of the plurality of regions, each PTE indicating the priority level based on a corresponding region of the one or more regions.

12. The non-transitory computer-readable medium, a computer program, or a program product, of claim 11, wherein each PTE includes a field for indicating the priority level, the field including one or more bits.

13. The non-transitory computer-readable medium, a computer program, or a program product, of claim 11, wherein for managing the cache of the processor, the instructions when executed by a processor, further cause the processor to:
obtain an instruction of the program code from the memory, the instruction indicating a priority level based on a corresponding PTE; and
allocate the instruction within the cache based on the priority level.

14. The non-transitory computer readable medium, a computer program, or a program product, of claim 13, wherein for allocating the instruction within the cache based on the priority level, the instructions when executed by the processor, further configure the processor to insert the instruction within the cache based on the priority level or replace an existing instruction in the cache with the instruction based on the priority level.

15. An apparatus comprising at least one processor and at least one machine-readable medium storing instructions, the instructions when executed by the at least one processor configure the apparatus to:
receive a program code, the program code including a plurality of regions, each of one or more regions having a corresponding indicator indicative of an associated level of execution frequency;
load the program code into a memory of a processor, wherein each of the one or more regions of the plurality of regions loaded into the memory is assigned a priority level based on the corresponding indicator; and
manage a cache of the processor running the program code, the managing based on the assigned priority level of each of the one or more regions.

16. The apparatus of claim 15, wherein loading the program code into the memory comprises generating page table entries, PTEs, corresponding to the one or more regions of the plurality of regions, each PTE indicating the priority level based on a corresponding region of the one or more regions.

17. The apparatus of claim 16, wherein each PTE includes a field for indicating the priority level, the field including one or more bits.

18. The apparatus of claim 16, wherein for managing the cache of the processor, the instructions when executed by the at least one processor, further cause the apparatus to:
obtain an instruction of the program code from the memory, the instruction indicating a priority level based on a corresponding PTE; and
allocate the instruction within the cache based on the priority level.

19. The apparatus of claim 18, wherein for allocating the instruction within the cache based on the priority level, the instructions when executed by the one or more processors further configure the apparatus to: insert the instruction within the cache based on the priority level or replace an existing instruction in the cache with the instruction based on the priority level.
